(19) United States
(12) Patent Application Publication
(10) Pub. No.: US 2007/0007895 A1
(43) Pub. Date: Jan. 11, 2007

(54) Rear Plate Structure and Manufacturing Method thereof for a Plasma Display Panel

(76) Inventor: Ching-Hui Lin, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/160,804

(22) Filed: Jul. 11, 2005

(51) Int. Cl. H01J 17/49

(52) U.S. Cl. 313/587; 313/582

(57) ABSTRACT

The present invention provides a rear plate structure for a plasma display panel. The rear plate structure includes a substrate, a plurality of parallel electrodes disposed on a surface of the substrate, a dielectric layer covering the electrodes and the surface of the substrate, a plurality of barrier ribs disposed on the dielectric layer, a reflective layer covering each side wall of the barrier ribs and the exposed dielectric layer, and a fluorescent layer covering the reflective layer.

### BACKGROUND OF THE INVENTION

1. Field of the Invention

The present invention relates to a rear plate structure and manufacturing method thereof for a plasma display panel (PDP), and more particularly, to a rear plate structure and manufacturing method thereof for increasing the reflectance of UV light and visible light to improve the efficiency of the PDP.

2. Description of the Prior Art

Recently, the plasma display panels (PDPs) include characteristics of being light weight, being thin, having large scale expandability, and having a wide angle of vision. In general, the illumination of plasma display panels is caused by illuminating the ultraviolet (UV) light produced by plasma onto fluorescent bodies, such that the light is visible from the fluorescent bodies.

Please refer to FIG. 1. FIG. 1 is a perspective diagram showing a plasma display panel 10 according to the prior art. As shown in FIG. 1, the plasma display panel 10 includes a housing (not shown), a rear plate 12, and a front plate 14 disposed in parallel above the rear plate 12. Therein, the rear plate 12 and the front plate 14 are composed of glass. A plurality of electrode pairs 16 is disposed in parallel over the lower surface of the front plate 14, in which each of the electrodes includes a common electrode 17, a scan electrode 18, a dielectric layer 20 disposed over the lower surface of the front plate 14 and covering the electrode pairs 16, and a passivation layer 22 composed of magnesium oxide (MgO) formed over the lower surface of the dielectric layer 20 for protecting the dielectric layer 20 from deterioration caused by plasma splashing. Additionally, a plurality of data electrodes 24 is disposed in parallel over the upper surface of the rear plate 12, a dielectric layer 26 is disposed above the upper surface of the rear plate 12 and covering the data electrodes 24, a plurality of barrier ribs 28 are disposed above the dielectric layer 26, and three different colors of phosphor including blue, red, and green of 30B, 30R, 30G are disposed between the barrier ribs 28. Moreover, ionized gases (not shown) are inserted between each two adjacent barrier ribs 28 and the top of the barrier ribs 28 is fixed over the lower surface of the passivation layer 22 to prevent the plasma on two sides of the barrier ribs 28 from interacting with each other.

The common electrode 17 and the scan electrode 18 both include a sustain electrode 32 and a bus electrode 34. The sustain electrode 32 is a transparent electrode having greater width, in which the electrode is typically composed of indium tin oxide (ITO) to initiate and sustain electricity. The bus electrode 34 on the other hand, is a thinner and non-transparent metal electrode, in which the electrode is usually composed chromium-copper-chromium or silver. Additionally, the bus electrode 34 is disposed in parallel over the surface of the sustain electrode 32 to support the sustain electrode 32 for generating electricity and reducing the electrical resistance of the common electrode 17 and scan electrode 18. Moreover, a plurality of blue display cells 36B, red display cells 36R, and green display cells 36G is formed at the meeting point of the data electrode 24 and the electrode pairs 16 to generate blue, red, and green light, in which the display cells are divided by the barrier ribs 28 individually.

However, a portion of UV light and visible light, which are generated from the discharge and the phosphor excitation respectively, will pass through the three colors of phosphor 30B, 30R, and 30G, the barrier ribs 28, the dielectric layer 26, and the rear plate 12, such that the efficiency of the plasma display panel 10 will be decreased, seriously influencing the performance of the plasma display panel 10.

### SUMMARY OF THE INVENTION

It is therefore an objective of the present invention to provide a rear plate structure and manufacturing method thereof for a plasma display panel to solve the above-mentioned problems.

According to the present invention, a rear plate structure for a plasma display panel includes a substrate, a plurality of parallel electrodes disposed on a surface of the substrate, a dielectric layer covering the electrodes and the surface of the substrate, a plurality of barrier ribs disposed on the dielectric layer, a reflective layer covering each side wall of the barrier ribs and the dielectric layer, and a fluorescent layer covering the reflective layer.

Additionally, the present invention also discloses another rear plate structure for a plasma display panel, in which the rear plate structure for a plasma display panel includes a substrate, a plurality of parallel electrodes disposed on a surface of the substrate, a dielectric layer covering the electrodes and the surface of the substrate, a plurality of barrier ribs disposed on the dielectric layer, a reflective layer covering each side wall of the barrier ribs and exposing the dielectric layer, and a fluorescent layer covering the reflective layer and the exposed dielectric layer.

Furthermore, the present invention discloses a manufacturing method of a rear plate for a plasma display panel, in which the manufacturing method of a rear plate includes providing a substrate, forming a plurality of parallel electrodes on a surface of the substrate, forming a dielectric layer covering the electrodes and the surface of the substrate, forming a plurality of barrier ribs on the dielectric layer, forming a reflective layer covering the barrier ribs and the dielectric layer, removing a portion of the reflective layer covering the top of the barrier ribs, and forming a fluorescent layer on the substrate.

According to the present invention, a rear plate structure for a plasma display panel utilizes a reflective layer, which has better reflectance of UV light and visible light, to prevent UV light and visible light, which are generated from the discharge and the phosphor excitation respectively, from passing through barrier ribs, a dielectric layer, and a substrate of the rear plate structure. Therefore, the efficiency and the performance of the plasma display panel are improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective diagram showing a plasma display panel according to the prior art.

FIG. 2 to FIG. 5 are schematic diagrams for illustrating a manufacturing method of a rear plate structure for a plasma display panel according to a first preferred embodiment of the present invention.

FIG. 6 to FIG. 9 are schematic diagrams for illustrating a manufacturing method of a rear plate structure for a plasma display panel according to a second preferred embodiment of the present invention.

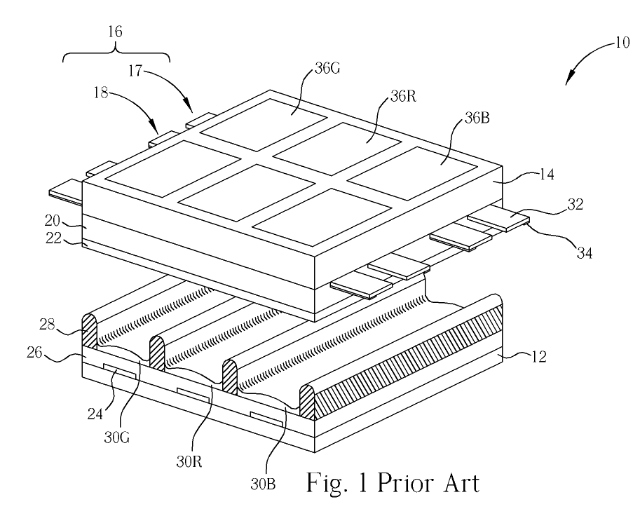

### DETAILED DESCRIPTION

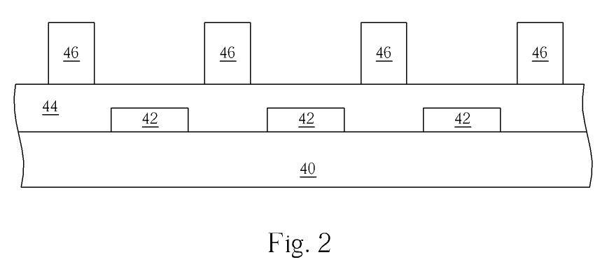

Please refer to FIG. 2 to FIG. 5. FIG. 2 to FIG. 5 are schematic diagrams for illustrating a manufacturing method of a rear plate structure 56 for a plasma display panel according to a first preferred embodiment of the present invention. As shown in FIG. 2, a substrate 40, for example, glass or quartz boards, is provided. The substrate 40 includes a plurality of parallel electrodes 42 disposed on a surface of the substrate 40, a dielectric layer 44 covering the electrodes 42 and the surface of the substrate 40, and a plurality of barrier ribs 46 disposed on the dielectric layer 44. Therein, the dielectric layer 44 is composed of transparent dielectric materials or non-transparent dielectric materials to provide the required capacitance, place constraints on the electrical current for preventing short circuits, and at the same time, accumulate electrical potentials. According to the first embodiment of the present invention, the barrier ribs 46 are parallel to each other and the electrodes 42. Nevertheless, in other embodiments, the barrier ribs 46 may include a plurality of parallel horizontal barrier ribs and a plurality of parallel vertical barrier ribs, where the vertical barrier ribs are parallel to the electrodes 42 and intersect the horizontal barrier ribs to form a close type barrier rib structure.

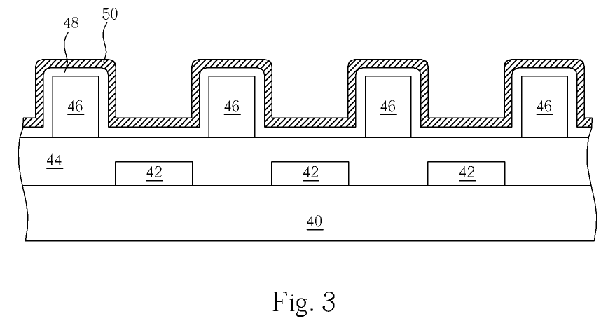

As shown in FIG. 3, a reflective layer 48 is formed by a sputtering deposition process or an evaporation deposition process to cover the barrier ribs 46 and the exposed dielectric layer 44. Therein, the reflective layer 48 is composed of aluminum (Al), magnesium oxide (MgO), rhodium (RH), or other materials, which have better reflectance of UV light and visible light. Optionally, a protective layer 50 is formed by a sputtering deposition process or an evaporation deposition process to cover the reflective layer 48 to prevent the reflective layer 48 from being oxidized. The protective layer 50 is composed of magnesium fluoride (MgF).

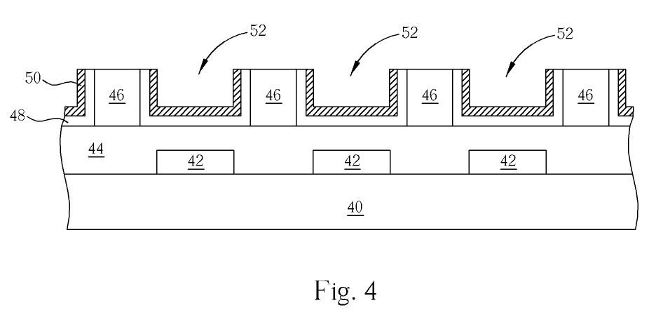

As shown in FIG. 4, since the protective layer 50 or the reflective layer 48 could be composed of conductive materials, which will influence the panel driving or data writing for each of cells 52, a polishing process is performed to remove the protective layer 50 and the reflective layer 48 covering the top of the barrier ribs 46. Then, the protective layer 50 and the reflective layer 48 cover each side wall of the barrier ribs 46 and the exposed dielectric layer 44.

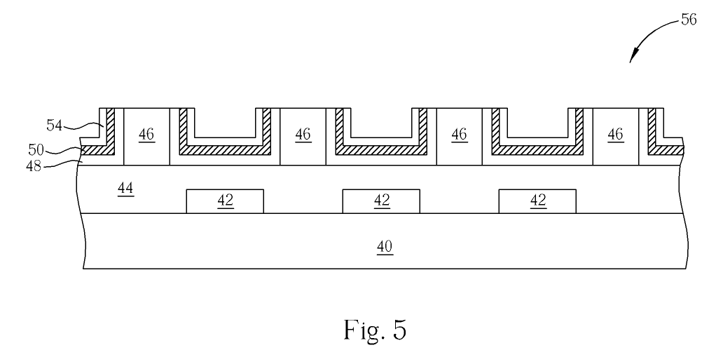

As shown in FIG. 5, a fluorescent layer 54 is formed on the substrate 40 by a printing process to cover the protective layer 50 and the reflective layer 48. Finally, a manufacturing method of a rear plate structure 56 is completed. Therein, the fluorescent layer 54 includes three different colors of phosphor including blue, red, and green (not shown in FIG. 5) disposed between the corresponding barrier ribs 46.

According to the first embodiment of the present invention, the rear plate structure 56 for a plasma display panel utilizes the reflective layer 48, which has better reflectance of UV light and visible light, to prevent UV light and visible light, which are generated from the discharge and the phosphor excitation respectively, from passing through the barrier ribs 46, the dielectric layer 44, and the substrate 40. Therefore, the efficiency and the performance of the plasma display panel are improved.

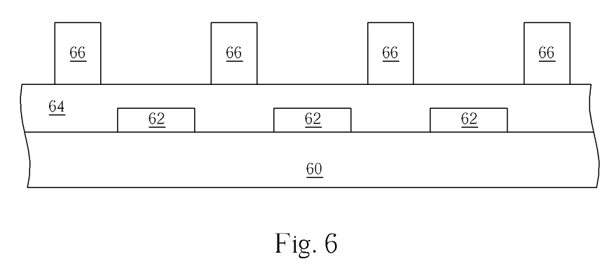

Please refer to FIG. 6 to FIG. 9. FIG. 6 to FIG. 9 are schematic diagrams for illustrating a manufacturing method of a rear plate structure 76 for a plasma display panel according to a second preferred embodiment of the present invention. The difference between the first embodiment and the second embodiment of the present invention is that the reflective layer does not cover the dielectric layer, which is located above the electrodes, for improving the performance of the plasma display panel, for example, operating voltage margin and so forth.

As shown in FIG. 6, a substrate 60, for example, glass or quartz boards, is provided. The substrate 60 includes a plurality of parallel electrodes 62 disposed on a surface of the substrate 60, a dielectric layer 64 covering the electrodes 62 and the surface of the substrate 60, and a plurality of barrier ribs 66 disposed on the dielectric layer 64. Therein, the dielectric layer 64 is composed of transparent dielectric materials or non-transparent dielectric materials to provide the required capacitance, place constraints on the electrical current for preventing short circuits and at the same time, accumulate electrical potentials. According to the second embodiment of the present invention, the barrier ribs 66 are parallel to each other and the electrodes 62. Nevertheless, in other embodiment, the barrier ribs 66 may include a plurality of parallel horizontal barrier ribs and a plurality of parallel vertical barrier ribs, where the vertical barrier ribs are parallel to the electrodes 62 and intersect the horizontal barrier ribs to form a close type barrier rib structure.

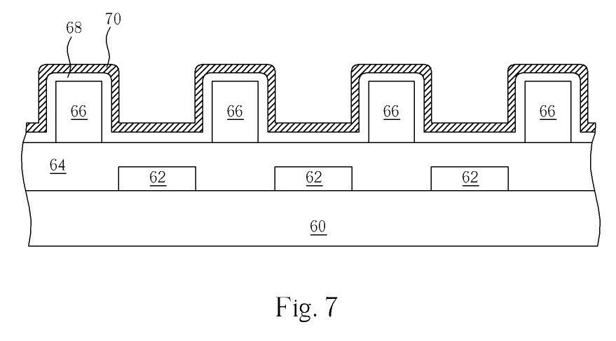

As shown in FIG. 7, a reflective layer 68 is formed by a sputtering deposition process or an evaporation deposition process to cover the barrier ribs 66 and the exposed dielectric layer 64. Therein, the reflective layer 68 is composed of aluminum, magnesium oxide, rhodium, or other materials, which have better reflectance of UV light and visible light. Optionally, a protective layer 70 is formed by a sputtering deposition process or an evaporation deposition process to cover the reflective layer 68 to prevent the reflective layer 68 from being oxidized. The protective layer 70 is composed of magnesium fluoride.

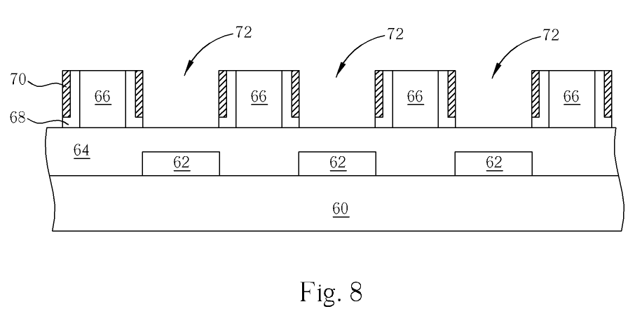

As shown in FIG. 8, since the protective layer 70 or the reflective layer 68 could be composed of conductive materials, which will influence the panel driving or data writing for each of cells 72, an etching process is performed to remove the protective layer 70 and the reflective layer 68 covering the top of the barrier ribs 66, and simultaneously remove the protective layer 70 and the reflective layer 68 covering the dielectric layer 64, which is located above the electrodes 62. Then, the protective layer 70 and the reflective layer 68 cover each sidewall of the barrier ribs 66 and expose the dielectric layer 64.

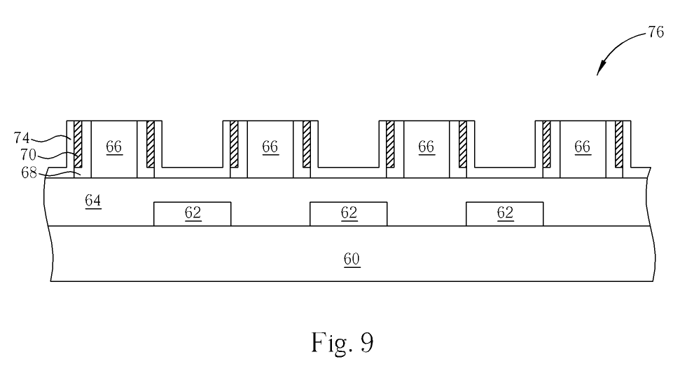

As shown in FIG. 9, a fluorescent layer 74 is formed on the substrate 60 by a printing process to cover the protective layer 70, the reflective layer 68, and the exposed dielectric layer 64. Finally, a manufacturing method of a rear plate structure 76 is completed. Therein, the fluorescent layer 74 includes three different colors of phosphor including blue, red, and green (not shown in FIG. 9) disposed between the corresponding barrier ribs 66.

According to the second embodiment of the present invention, the rear plate structure 76 for a plasma display panel utilizes the reflective layer 68 and the electrodes 62, which have better reflectance of UV light and visible light, to prevent UV light and visible light, which are generated from the discharge and the phosphor excitation respectively, from passing through the barrier ribs 66, the dielectric layer 64, and the substrate 60. Therefore, the efficiency and the performance of the plasma display panel are improved. Moreover, the reflective layer 68 does not cover the dielectric layer 64, which is located above the electrodes 62, for improving the performance of the plasma display panel, for example, operating voltage margin and so forth.

Compared to the prior art, a rear plate structure of the present invention utilizes a reflective layer, which has better reflectance of UV light and visible light, to prevent UV light and visible light, which are generated from the discharge and the phosphor excitation respectively, from passing through barrier ribs, a dielectric layer, and a substrate of the rear plate structure. Therefore, the efficiency and the performance of the plasma display panel are improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A rear plate structure for a plasma display panel, comprising:
a substrate;
a plurality of parallel electrodes disposed on a surface of the substrate;
a dielectric layer covering the electrodes and the surface of the substrate;
a plurality of barrier ribs disposed on the dielectric layer;
a reflective layer reflecting both UV light and visible light and covering each side wall of the barrier ribs and the dielectric layer; and
a fluorescent layer covering the reflective layer.

2. The rear plate structure for a plasma display panel of claim 1, wherein the reflective layer is composed of aluminum (Al), magnesium oxide (MgO), or rhodium (RH).

3. The rear plate structure for a plasma display panel of claim 1 further comprising a protective layer covering the reflective layer to prevent the reflective layer from being oxidized.

4. The rear plate structure for a plasma display panel of claim 3, wherein the protective layer is composed of magnesium fluoride (MgF).

5. A rear plate structure for a plasma display panel, comprising:
a substrate;
a plurality of parallel electrodes disposed on a surface of the substrate;
a dielectric layer covering the electrodes and the surface of the substrate;
a plurality of barrier ribs disposed on the dielectric layer;
a reflective layer covering each side wall of the barrier ribs and exposing the dielectric layer; and
a fluorescent layer covering the reflective layer and the exposed dielectric layer.

6. The rear plate structure for a plasma display panel of claim 5, wherein the reflective layer reflects both UV light and visible light.

7. The rear plate structure for a plasma display panel of claim 5, wherein the reflective layer is composed of aluminum, magnesium oxide, or rhodium.

8. The rear plate structure for a plasma display panel of claim 5 further comprising a protective layer covering the reflective layer to prevent the reflective layer from being oxidized.

9. The rear plate structure for a plasma display panel of claim 8, wherein the protective layer is composed of magnesium fluoride.

10. A manufacturing method of a rear plate for a plasma display panel, comprising:
providing a substrate;
forming a plurality of parallel electrodes on a surface of the substrate;
forming a dielectric layer covering the electrodes and the surface of the substrate;
forming a plurality of barrier ribs on the dielectric layer;
forming a reflective layer covering the barrier ribs and the dielectric layer;
removing a portion of the reflective layer, wherein the portion of the reflective layer covers the top of the barrier ribs; and
forming a fluorescent layer on the substrate.

11. The manufacturing method of a rear plate for a plasma display panel of claim 10, wherein the reflective layer is formed by a first sputtering deposition process or a first evaporation deposition process.

12. The manufacturing method of a rear plate for a plasma display panel of claim 10, wherein the portion of the reflective layer covering the top of the barrier ribs is removed by a polishing process.

13. The manufacturing method of a rear plate for a plasma display panel of claim 10, wherein the portion of the reflective layer covering the top of the barrier ribs is removed by an etching process and the reflective layer covering the dielectric layer is removed by the etching process simultaneously.

14. The manufacturing method of a rear plate for a plasma display panel of claim 10 further comprising forming a protective layer covering the reflective layer to prevent the reflective layer from being oxidized.

15. The manufacturing method of a rear plate for a plasma display panel of claim 14, wherein the protective layer is formed by a second sputtering deposition process or a second evaporation deposition process.
